(19) United States
(12) Patent Application Publication
(10) Pub. No.: US 2008/0277848 A1
(43) Pub. Date: Nov. 13, 2008

(54) SHOCK ABSORBER FORK DAMPER

(76) Inventor: Terry Davis, Hesperia, CA (US)

Correspondence Address: BLACK LOWE & GRAHAM, PLLC, 701 FIFTH AVENUE, SUITE 4800, SEATTLE, WA, 98104, US

(21) Appl. No.: 11/745,962

(22) Filed: May 8, 2007

(51) Int. Cl. B62K 25/08; F16D 57/00

(52) U.S. Cl. 267/217; 188/266

(57) ABSTRACT

A telescopic shock absorber for a motorcycle includes a slider tube, a stanchion tube, a damping valve, and a hollow damping rod. The damping rod includes a lower end portion secured within the slider tube with a plurality of longitudinally offset orifices. At least one of the orifices is positioned near the valve such that the orifice moves above the valve under sufficient compressive shock to the slider tube during riding. The damping rod also includes an upper end portion extending within the lower end of the stanchion tube. A mid-portion extends between the upper and lower end portions with an outer diameter smaller than those of the end portions. Steps are provided between the mid-portion and the upper and lower end portions. The mid-portion is positioned adjacent the damping valve when the vehicle is in a static, rider-sag state.

### FIELD OF THE INVENTION

This invention relates generally to vehicle shock absorbers and, more specifically, to damping rods for motorcycle front-fork suspensions.

### BACKGROUND OF THE INVENTION

The conventional arrangement of a street motorcycle includes a front fork arrangement having telescoping fork legs with springs therein to absorb impacts encountered in uneven road surfaces or terrain. A damper is employed to attenuate bouncing motion that would otherwise occur.

A typical arrangement includes a slider tube and a stanchion tube with a damper rod secured to the bottom of the slider tube. The head of the rod extends into the stanchion tube. When an uneven road surface or terrain feature is encountered, the slider tube is able to move relative to the stanchion tube in telescoping fashion. The spring tends to resist the collapse of the slider tube and stanchion tube together while the damper resists motion in either direction by using a hydraulic fluid forced through orifices and valves. Even simple damping arrangements are a definite improvement over no shock attenuation or damping. However, the ride may still be somewhat harsh and may contribute to lack of control of the motorcycle as the front wheel does not stay firmly planted on terrain or road surfaces. For example, low amplitude bumps may create a jarring effect on the rider and slightly remove the front wheel from optimal traction with the road surface. This occurs because the shock-absorber system is set for handling large bumps without the slider and stanchion tubes hitting their fully collapsed state (i.e., “bottoming out” the shock absorber damping system).

### SUMMARY OF THE INVENTION

The present invention provides an improvement over standard damping systems for street motorcycles for softer suspension action over small bumps while still providing bottoming resistance for large bumps or other road or terrain features. Thus, the damping system provides a modified progressive suspension arrangement.

The system does so with a damping rod for a load-carrying, telescoping-tube shock absorber. The shock absorber includes a slider tube, a stanchion tube, and a spring. The tubes have first ends and second ends with the first end of the stanchion tube telescopically nested within the second end of the slider tube. The stanchion tube has a damping valve at the first end thereof. The rod includes first, second, and mid-portions. The first portion is securable to the inside of the slider tube at the first end. The first portion has a first cross-sectional size. The second portion is insertable within the first end of the stanchion tube. The second portion is couplable to the spring.

The mid-portion is situated between the first and second portions. The mid-portion includes a mid-portion cross-sectional size smaller than the first cross-sectional size of the first portion. Thus, a step is formed between the first portion and the mid-portion. The mid-portion is positioned adjacent the damping valve when assembled in the shock absorber with the shock absorber under the weight of the load carried thereon (i.e., rider sag).

Preferably, the second portion also includes a second cross-sectional size larger than the mid-portion cross-sectional size. Thus, the mid-portion forms a groove between the first and second portions. Preferably, the groove is less than about one fourth of the length of the rod or less than 3 inches in total length. Furthermore, the groove depth is less than 30 percent of the thickness of the rod.

A step is preferably formed between the second portion and the mid-portion where the cross-sectional sizes change between the two. The steps between the mid-portion and the first and second portions are angled in the preferred embodiment.

Most preferably, the length of the groove is approximately 1.5 inches. The groove is positioned under the static weight of the load with the valve approximately 0.5 inch from the second portion and one inch from the first portion.

A further aspect of the preferred embodiment of the invention includes a plurality of longitudinally offset orifices. In this embodiment, the first, second, and mid-portions of the rod are hollow. The longitudinally offset orifices are positioned through the side of the first portion of the rod. At least one of the plurality of orifices is positioned in the path of the valve such that the valve passes over the orifice with sufficient compression of the shock tubes. The orifices are positioned on opposite sides of the rod.

In one aspect of the preferred embodiment of the invention the cross sections of the first and second portions are circular and of approximately constant diameter along most of their respective lengths. The cross-section of the mid-portion is also preferably circular between the steps.

The groove with the steps being of smaller diameter than the first and second portions and being positioned initially adjacent the valve at the bottom of the stanchion tube provides a soft damping action for less resistance to motion of the slider tube relative to the stanchion tube initially during compression or rebound of the shock absorber fork. Thus, small impacts or drops to the slider are felt less by the rider and the wheel is able to track the road surface or terrain more readily. However, upon slightly larger impacts the valve passes over the steps thus tightening the interface between the valve and the damper tube to increase damping such that motion of the slider tube is more restrained relative to the stanchion tube. This effect is further amplified once the valve passes over one of the orifices, thus effectively shutting down the fluid by-pass through the hollow center of the damper tube to some degree. As the valve passes over more orifices this effect is further amplified. Thus, bottoming resistance is improved. Thereby, the arrangement of the present invention provides softer, smoother suspension of the front forks with low amplitude road features while still providing improved total bottoming resistance.

### BRIEF DESCRIPTION OF THE DRAWINGS

Preferred and alternative embodiments of the present invention are described in detail below with reference to the following drawings:

FIG. 1 is an exploded view of one fork of the present invention;

FIG. 2 is a detailed view of the damping rod; and

FIGS. 3A-E illustrate cross-sectional elevational views of the interaction of the stanchion tube, slider tube, and damping rod in various telescoping states that may be encountered during suspension action.

### DETAILED DESCRIPTION OF THE PREFERRED EMBODIMENT

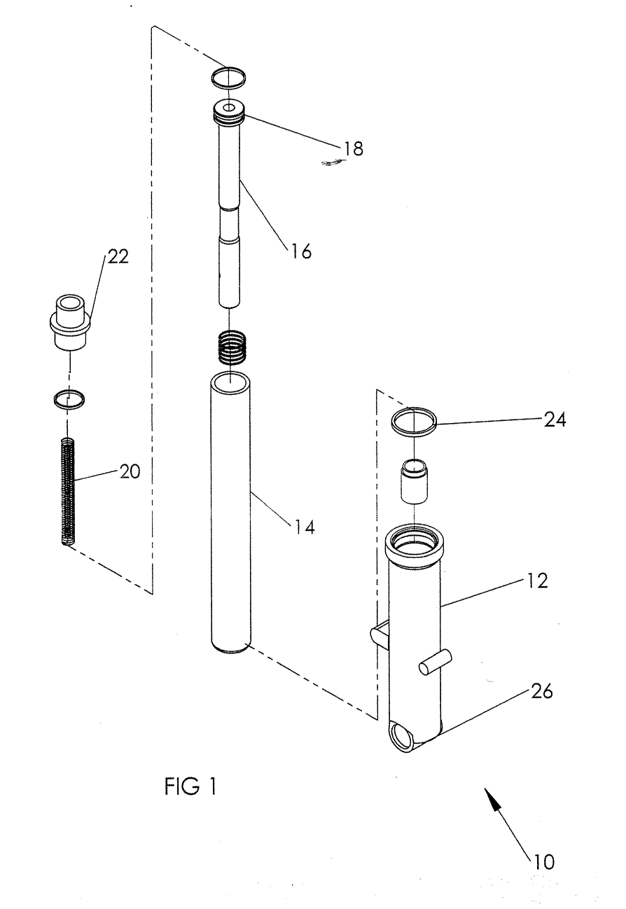

FIG. 1 illustrates an exploded view of the fork of the present invention. A shock absorber fork 10 is provided that includes a slider tube 12 and a stanchion tube 14. The slider tube and stanchion tube are nested together in telescoping fashion.

A damper tube 16 is also provided that includes a head 18, preferably at an upper end thereof. A spring 20 is compressed between the top of head 18 and a bolt 22 secured to the upper end of stanchion tube 14.

A seal 24 is conventionally provided at the top of slider tube 12 to interface with stanchion tube 14 to help contain the hydraulic fork oil used as a damping fluid within the arrangement. The bottom of slider tube 12 includes an axle mount 26 for securing the front wheel to be positioned between two forks. The top of stanchion tube 14 is typically secured to a clamp arrangement (triple clamp) that also secures a second stanchion tube from a second fork leg, a steerer tube (not shown), and the handlebars of the vehicle for steering the front wheel.

A valve 28 is positioned with the bottom of stanchion tube 14. As will be described in more detail below, valve 28 surrounds the shaft of damper tube 16 to provide the damping action for shock absorber fork 10.

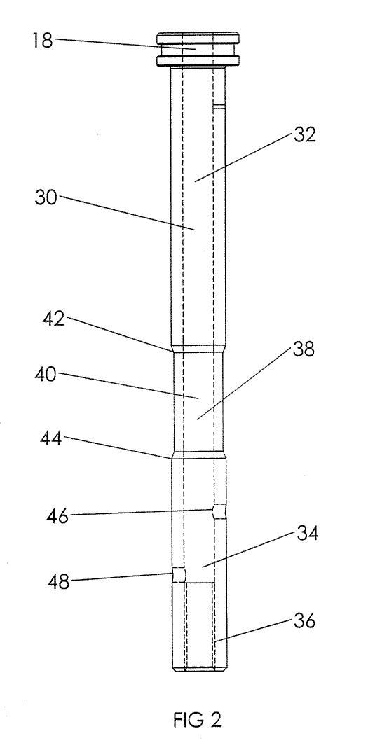

FIG. 2 illustrates the detail of damper tube 16 in the preferred embodiment. Damper tube 16 includes a shaft having an upper portion 32 and a lower portion 34. Upper and lower portions 32 and 34 are preferably hollow with constant inner and outer circular diameters. In other embodiments, they may be solid or may have noncircular cross-sections. Lower portion 34 includes a threaded opening at its lower most end for securement of the fastener to the bottom of slider tube 12 as will be described in more detail below. A mid-portion 38 is positioned between upper and lower portions 32 and 34. Mid-portion 38 includes a reduced outer diameter forming a groove or recess 40. Groove 40 interfaces with upper portion 32 with an upper step 42. Likewise, the transition between groove 40 and lower portion 34 is accomplished with a lower step 44. Upper step 42 and lower step 44 typically have a slightly sloped surface for a smooth transition between mid-portion and the upper and lower portions. The slope of the step may be greater or lesser to provide such a transition. However, the steps are relatively small along the overall length of the rod compared to the length of groove 40. In the preferred embodiment, the length of groove 40 is approximately 1.5 inches with each of the steps being less than a fourth of the length of groove 40. The steps are each preferably about one-tenth the length of groove 40. The groove may extend over a larger portion of the damper tube 16. In one alternative embodiment, groove 40 may extend approximately 3 inches. Various other lengths may be used, depending on the specific application. In the preferred embodiments, groove 40 is less than about one-fourth of the length of shaft 30.

Lower portion 34 preferably includes an upper orifice 46 and a lower orifice 48 extending through the sidewall to the hollow interior of shaft 30. Upper orifice 46 is preferably positioned such that valve 28 will pass thereover during large compressive forces on slider tube 12. Lower orifice 48 may also pass through valve 28 under extreme compressive forces. In the preferred embodiment, two orifices are provided. However, additional orifices may be provided in alternative embodiments along the length of lower portion 34. These orifices provide a bypass for the damping fluid to pass through the middle of shaft 30 to exit through the top of head 18 during compressive telescopic action of shock absorber fork 10. The total length of damper tube 16 is preferably approximately 9 inches. Lower orifice 48 is preferably approximately 1.25 inches from the lower end thereof. Upper orifice 46 is approximately 2.25 inches from the bottom thereof. Note that in certain shock absorber arrangements the entire assembly may be reversed such that slider tube 12 would be above stanchion tube 14 in an inverted fashion. In such an arrangement the damper tube 16 would also be inverted.

In the preferred embodiment, lower step 44 is positioned approximately 3 inches from the bottom of damper tube 16 with upper step 42 being approximately 4.5 inches from the bottom.

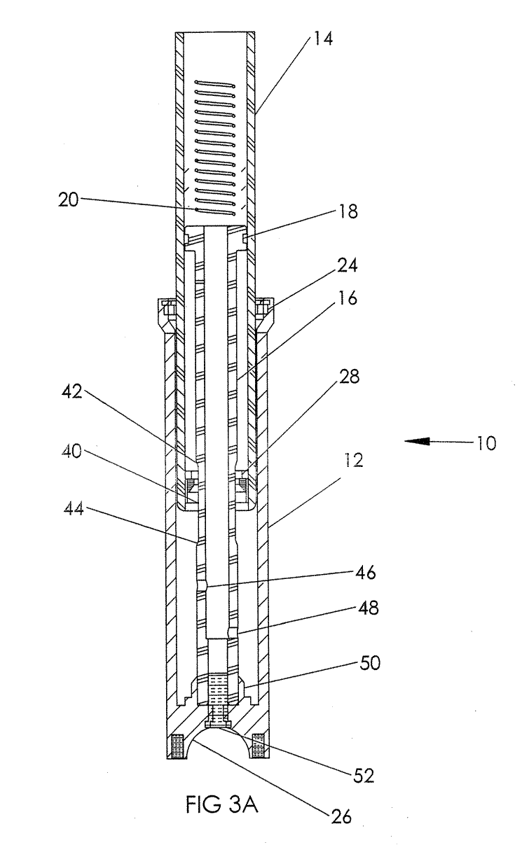

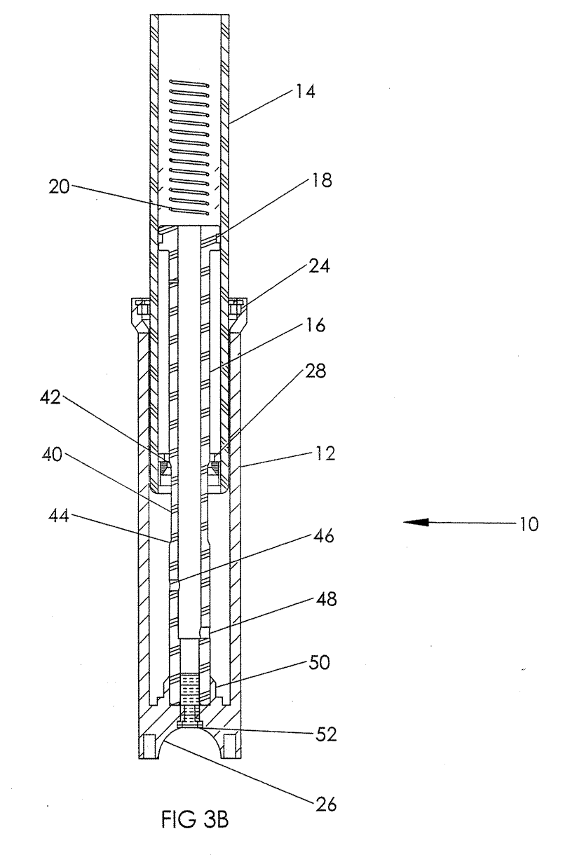

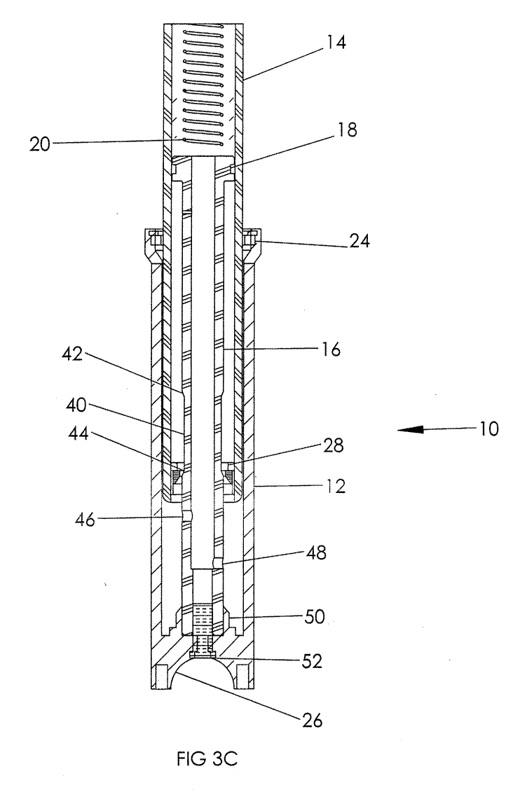

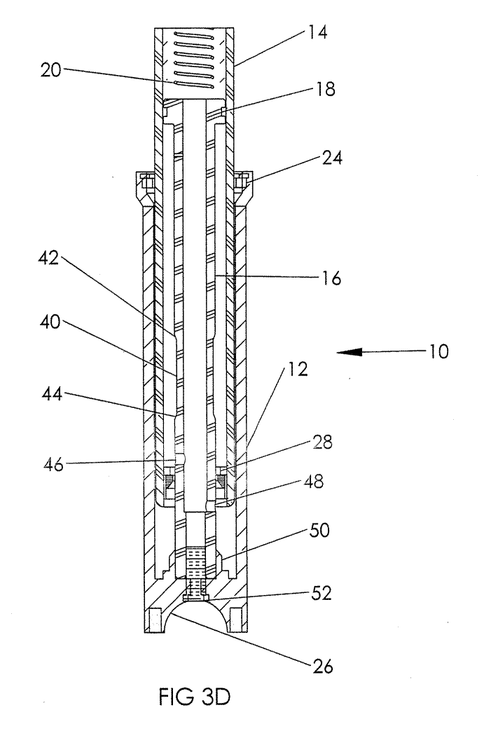

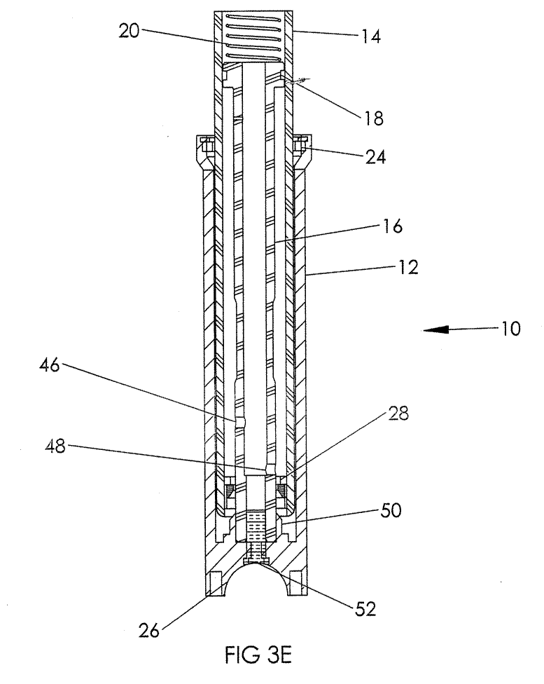

FIGS. 3A-E illustrate cross-sectional elevational views of various damper tube 16 positioning relative to valve 28. FIG. 3A illustrates a preferred positioning where the tubes are in a static state with rider sag. This is the position where the shock absorber is supporting the weight of the vehicle as well as the weight of the rider and any other load thereon. The preload of spring 20 is set to preferably position the valve 28 adjacent the upper third of groove 40. In this position, the valve 28 may travel during a compressive force on slider tube 12 over about an inch while still remaining adjacent groove 40. Slider tube 12 may extend approximately 0.5 inches for small drops in road surface while valve 28 still stays adjacent groove 40. Groove 40 thus allows hydraulic fluid to pass between damper tube 16 and valve 28 with relative ease such that small bumps and drops are not felt as harsh or unsmooth terrain by the rider. Furthermore, the front wheel is better able to track such small road surface features. In this range, spring 20 has not been significantly compressed or extended such that minimal damping is required to attenuate unwanted motion. Thus, groove 40 provides modified damping action versus the standard arrangement with no groove.

FIGS. 3A-E further illustrate differing telescopic compressions and relative positioning of the various parts of shock absorber fork 10. Most of these parts have been discussed in some detail above. However, the attachment of damper tube 16 to the bottom of slider tube 12 is detailed. A fastener 52 secures the lower threaded end of damper tube 16 to the bottom interior of slider tube 12. Furthermore, a rod sleeve 50 is positioned on the bottom of damper tube 16. This also helps shut down damper fluid movement to restrain further compressive motion of slider tube 12 relative to stanchion tube 14 under extreme bottoming conditions. Thus, the top of rod sleeve 50 may interact with the bottom of stanchion tube 12 to have the effect of sealing the two substantially for no damping fluid to further pass through. Other conventional and non-conventional means of resisting bottoming may be employed, such as springs or bumpers. Such are known in the art.

FIG. 3B illustrates the situation where the front tire drops into a small hole or recess in the road surface. Valve 28 is then able to drop quickly, at least a half an inch to the top of groove 40 to follow such terrain. The reduced damping effect in this region of groove 40 allows such wheel tracking to take place. Once valve 28 moves more than 0.5 inch, in the preferred embodiment, increased damping occurs by passing valve 28 along the larger diameter upper portion 32 of shaft 30.

FIG. 3C illustrates the situation where a small terrain bump is encountered with slider tube 12 extending approximately an inch up on stanchion tube 14. In this position valve 28 is approximately adjacent lower step 44. This is where increased damping begins to occur when slightly larger bumps are encountered.

FIG. 3D illustrates a larger impact scenario where valve 28 passes upper orifice 46. In this situation upper orifice 46 is blocked substantially from allowing hydraulic damping fluid to pass therethrough. Thus, the damping force is increased to progressively increase the stiffness of the suspension arrangement. The positioning of upper orifice 46 provides another modified damping range versus the standard arrangement with the holes provided only lower on rod 16 near lower orifice 48.

Upon a much larger force, valve 28 may pass lower orifice 48 to further shut down motion for further bottoming resistance. Finally, damping essentially shuts down further suspension compression with the lower end of slider tube 12 passing over rod sleeve 50.

Thus, the arrangement having of groove 40, along with orifices 46 and 48 provides a modified progressive suspension system that allows for supple absorbing of high-frequency, small amplitude bumps, while allowing more resistance to bottoming under high amplitude bumps. Increased comfort and control result. The system is also simple to implement in current suspension systems with a switched or modified damping rod.

While the preferred embodiments of the invention have been illustrated and described, as noted above, many changes can be made without departing from the spirit and scope of the invention. For example, in one alternate embodiment additional orifices are provided along rod 16. The length of groove 40 is modified in one alternate embodiment. Various differing diameters of groove 40 are provided in one embodiment. Accordingly, the scope of the invention is not limited by the disclosure of the preferred embodiment. Instead, the invention should be determined by reference to the claims that follow.

The embodiments of the invention in which an exclusive property or privilege is claimed are defined as follows:

1. A damping rod for a load-carrying telescoping-tube shock absorber having a slider tube, a stanchion tube, and a spring, the tubes having first ends and second ends with the first end of the stanchion tube telescopically nested within the second end of the slider tube, the stanchion tube having a damping valve at the first end thereof, the rod comprising:
a first portion securable to the inside of the slider tube at the first end thereof, said first portion having a first cross-sectional size;
a second portion insertable within the first end of the stanchion tube, said second portion being couplable to the spring; and
a mid-portion between the first and second portions, said mid-portion having a mid-portion cross-sectional size smaller than the first cross-sectional size of the first portion such that a step is formed between said first portion and said mid-portion, said mid-portion being positioned to be adjacent the damping valve when assembled in the shock absorber with the shock absorber under the weight of the load carried thereon.

2. The damping rod of claim 1, wherein said second portion includes a second cross-sectional size larger than the mid-portion cross-sectional size such that said mid-portion forms a groove between the first and second portions.

3. The damping rod of claim 2, wherein the length of the groove is less than three inches.

4. The damping rod of claim 3, wherein the depth of the groove is less than thirty percent of the thickness of the rod.

5. The damping rod of claim 3, wherein the length of the groove is approximately 1.5 inches.

6. The damping rod of claim 5, wherein the groove is positioned under the static weight of the load with the valve approximately 0.5 inches from the second portion and 1.0 inch from the first portion.

7. The damping rod of claim 2, wherein the first, second, and mid-portions of the rod are hollow and wherein the first portion of the rod further includes a plurality of longitudinally offset orifices, at least one of said plurality of orifices being positioned in the path of the valve.

8. The damping rod of claim 7, wherein said orifices are positioned on opposite sides of the first portion of the rod.

9. The damping rod of claim 2, wherein the cross sections of the first and second portions are circular and of approximately constant diameter along most of their respective lengths.

10. The damping rod of claim 2, wherein a step is formed between the second portion and the mid-portion and wherein the steps between the mid-portion and the first and second portions are angled.

11. The damping rod of claim 2, wherein the length of the groove is less than one-fourth the length of the damping rod.

12. The damping rod of claim 1, wherein the first portion, second portion, and mid-portion of the rod are hollow, said first portion having a plurality of longitudinally offset orifices through sides thereof into the hollow.

13. The damping rod of claim 1, wherein the step is less than 30 percent of the thickness of the first portion.

14. The damping rod of claim 1, wherein the cross-section of the first portion is circular and of approximately constant diameter along most of its length.

15. A telescopic shock absorber for a vehicle comprising:
a slider tube having a first end and a second end;
a stanchion tube having a first end and a second end, the first end of the stanchion tube being slidably inserted within the second end of the slider tube;
a damping valve secured within the first end of the stanchion tube; and
a damping rod having a first end portion, a second portion, and a mid-portion between the first and second end portions, the first end portion being secured within the slider tube at the first end of the slider tube, the second end portion extending within the first end of the stanchion tube, wherein the mid-portion has an outer cross-sectional area smaller than an outer cross-sectional area of the first end portion with a step between the mid-portion and the first end portion, said mid-portion being positioned adjacent said damping valve when in a static equilibrium state under the vehicle load.

16. The shock absorber of claim 15, wherein said damping rod is hollow along at least a majority of its length, wherein the first end portion of said damping rod includes a plurality of longitudinally offset orifices, at least one of said orifices being in the path of said damping valve.

17. The shock absorber of claim 16, wherein the outer cross-sectional area of the second end portion is greater than the outer cross-sectional area of the mid-portion, the mid-portion forming a groove between the first and second end portions.

18. The shock absorber of claim 17, wherein the length of the groove is less than one-fourth the length of the entire damping rod.

19. The shock absorber of claim 16, wherein at least two of said orifices are not aligned.

20. A telescopic shock absorber for a motorcycle comprising:
a slider tube having a lower end and an upper end;
a stanchion tube having a lower end and an upper end, the lower end of the stanchion tube being slidably inserted within the upper end of the slider tube;
a damping valve secured within the lower end of the stanchion tube;
a hollow damping rod including:
a lower end portion secured within the slider tube at the lower end of the slider tube, said lower end portion having a plurality of longitudinally offset orifices, each orifice extending from the exterior of the damping rod to the hollow portion of the damping rod, at least one of the orifices being positioned near the valve such that the orifice moves above the valve under sufficient compressive shock to the slider tube during riding;
an upper end portion extending within the lower end of the stanchion tube; and
a mid-portion extending between the upper end portion and the lower end portion, said mid-portion having an outer diameter smaller than the outer diameters of the lower and upper end portions with steps between the mid-portion and the upper and lower end portions, said mid-portion being positioned adjacent said damping valve when in a static vehicle, rider-sag state.
